(19) United States
(12) Patent Application Publication
(10) Pub. No.: US 2017/0091790 A1
(43) Pub. Date: Mar. 30, 2017

(54) DATA PROCESSING SYSTEM FOR OPTIMIZING INVENTORY PURCHASING AND METHOD THEREFOR

(71) Applicant: WAL-MART STORES, INC., Bentonville, AR (US)

(72) Inventors: Shubhankar Ray, Union City, CA (US); Brian Seaman, San Francisco, CA (US); Ashin Mukherjee, Mountain View, CA (US)

(73) Assignee: WAL-MART STORES, INC., Bentonville, AR (US)

(21) Appl. No.: 14/869,564

(22) Filed: Sep. 29, 2015

(51) Int. Cl. G06Q 30/02; G06Q 10/08

(52) U.S. Cl. CPC G06Q 30/0202; G06Q 10/087

(57) ABSTRACT

A system and method for optimizing inventory purchasing is presented. A system can include one or more processing modules and one more non-transitory storage modules. The storage modules can contain instructions that perform acts corresponding to optimizing inventory purchasing, particularly for seasonal items. The demand for related items can be rolled-up to create a more complete base from which to make calculations. Price can be used to create a more accurate measure of demand. One can also forecast the effect of a future price reduction on demand. This more accurate measure of demand can then be used to order goods. Other embodiments are also disclosed herein.

### TECHNICAL FIELD

This disclosure relates generally to retail sales and more particularly to a system and method for optimizing inventory of a retailer.

### BACKGROUND

A retailer stocks goods for sale to the public based on a forecast of future sales. While certain items are sold year round, some items are considered seasonal and are stocked only during certain times of the year. Some seasonal items can be stocked only a limited number of times per year. It would be desirable to accurately forecast inventory needed to satisfy the demand for seasonal items.

### BRIEF DESCRIPTION OF THE DRAWINGS

To facilitate further description of the embodiments, the following drawings are provided in which:

FIG. 1 illustrates a front elevation view of a computer system that is suitable for implementing an embodiment of the system;

FIG. 2 illustrates a representative block diagram of an example of the elements included in the circuit boards inside a chassis of the computer system of FIG. 1;

FIG. 3 is a representative block diagram of a system according to an embodiment;

FIG. 4 presents an exemplary hierarchy of goods;

FIG. 5 is an exemplary sales/price scatter plot;

FIG. 6 is a graph illustrating the relationship between sales and price over time;

FIG. 7 is a flowchart illustrating the operation of an exemplary embodiment; and

FIG. 8 is a block diagram of a system of an exemplary embodiment.

For simplicity and clarity of illustration, the drawing figures illustrate the general manner of construction, and descriptions and details of well-known features and techniques might be omitted to avoid unnecessarily obscuring the present disclosure. Additionally, elements in the drawing figures are not necessarily drawn to scale. For example, the dimensions of some of the elements in the figures might be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but might include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements can be electrically coupled together, but not be mechanically or otherwise coupled together. Coupling can be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

In one embodiment, a system might comprise: one or more processing modules; and one or more non-transitory storage modules storing computing instructions configured to run on the one or more processing modules and perform the acts of: accessing historical sales data related to a set of stock keeping units (SKUs) from a database; associating, for each SKU in the set of SKUs, the SKU with a fineline comprising one or more SKUs with similar characteristics; imputing historical sales data for each SKU in the set of SKUs in the fineline to each SKU in the fineline; calculating demand data for each SKU in the set of SKUs based on the imputed historical sales data; and ordering goods based on the demand data.

In one embodiment, a method might comprise: accessing historical sales data related to a set of stock keeping units (SKUs) from a database; associating, for each SKU in the set of SKUs, the SKU with a fineline comprising one or more SKUs with similar characteristics; imputing historical sales data for each SKU in the set of SKUs in the fineline to each SKU in the fineline; calculating demand data for each SKU in the set of SKUs based on the imputed historical sales data; and ordering goods based on the demand data.

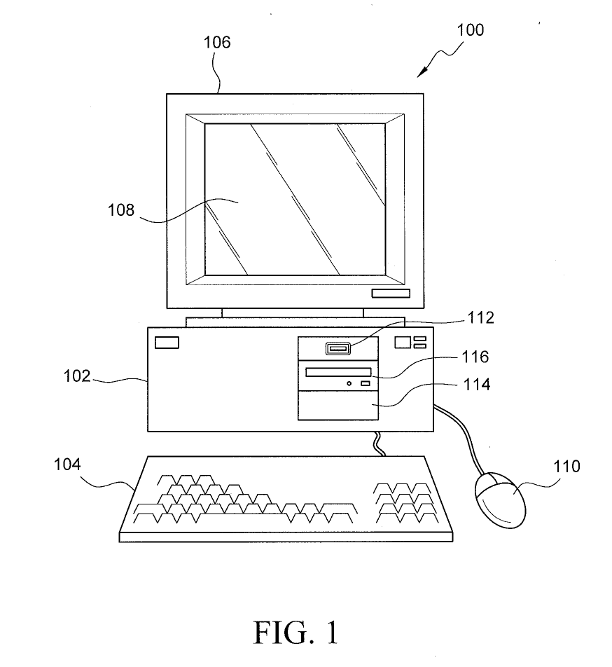

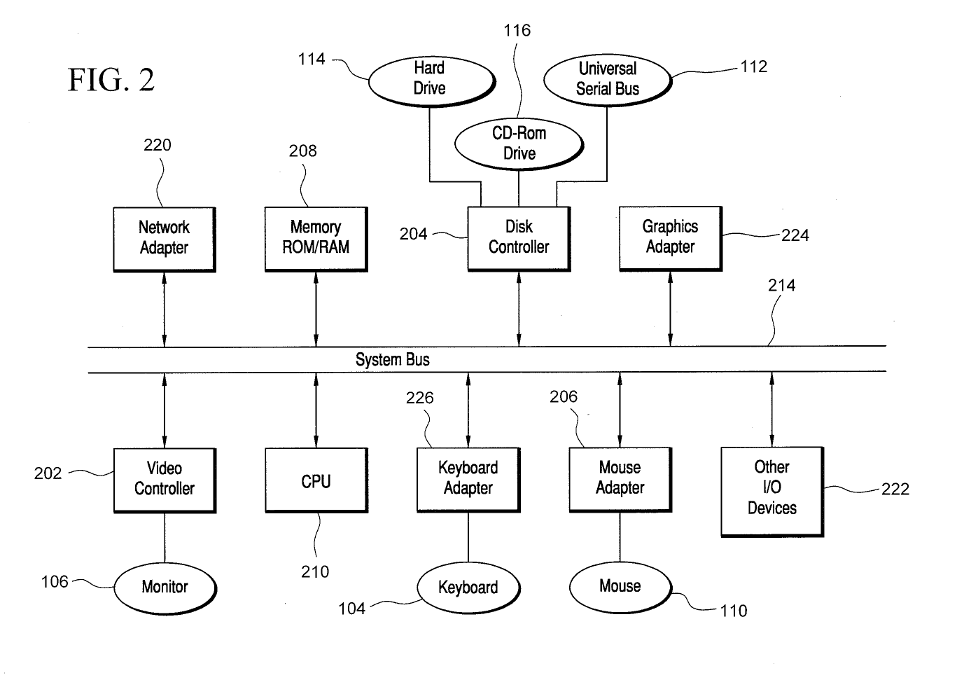

Turning to the drawings, FIG. 1 illustrates an exemplary embodiment of a computer system 100, all of which or a portion of which can be suitable for implementing the techniques described herein. As an example, a different or separate one of a chassis 102 (and its internal components) can be suitable for implementing the techniques described herein. Furthermore, one or more elements of computer system 100 (e.g., a refreshing monitor 106, a keyboard 104, and/or a mouse 110, etc.) also can be appropriate for implementing the techniques described herein. Computer system 100 comprises chassis 102 containing one or more circuit boards (not shown), a Universal Serial Bus (USB) port 112, a Compact Disc Read-Only Memory (CD-ROM), Digital Video Disc (DVD) drive, or Blu-ray drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 comprises both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can comprise microcode such as a Basic Input-Output System (BIOS) or Unified Extensible Firmware Interface (UEFI). In some examples, the one or more memory storage units of the various embodiments disclosed herein can comprise memory storage unit 208, a USB-equipped electronic device, such as, an external memory storage unit (not shown) coupled to universal serial bus (USB) port 112 (FIGS. 1-2), hard drive 114 (FIGS. 1-2), and/or CD-ROM, DVD drive, or Blu-ray drive 116 (FIGS. 1-2). In the same or different examples, the one or more memory storage units of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Some examples of common operating systems can comprise various versions/distributions of Microsoft® Windows® operating system (OS), Apple® OS X, UNIX® OS, and Linux® OS.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

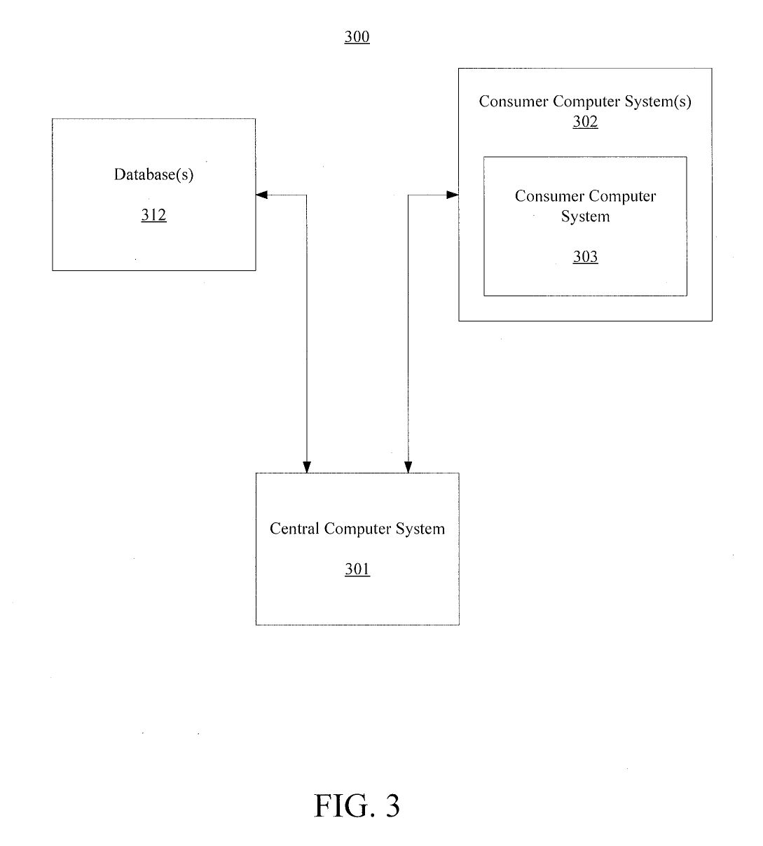

Skipping ahead now in the drawings, FIG. 3 illustrates a representative block diagram of a system 300, according to an embodiment. System 300 is merely exemplary and embodiments of the system are not limited to the embodiments presented herein. System 300 can be employed in many different embodiments or examples not specifically depicted or described herein. In some embodiments, certain elements or modules of system 300 can perform various methods and/or activities of those methods. In these or other embodiments, the methods and/or the activities of the methods can be performed by other suitable elements or modules of system 300.

As further described in greater detail below, in these or other embodiments, system 300 can proactively (e.g., prospectively) and/or reactively (e.g., responsively) determine and/or communicate the consumer product information to the consumer, as desired. Proactive acts can refer to acts (e.g., identification, determination, communication, etc.) performed without consideration of one or more predetermined acts performed by the consumer; and reactive acts can refer to acts (e.g., identification, determination, communication, etc.) performed with consideration of (i.e., in response to) one or more predetermined acts performed by the consumer. For example, in some embodiments, the predetermined act(s) can comprise an act of identifying a selection of a consumer product by the consumer.

Meanwhile, as also described in greater detail below, system 300 can be implemented in brick-and-mortar commerce and/or electronic commerce applications, as desirable. Further, in many of these or other embodiments, system 300 can communicate the consumer product information to the consumer substantially in real-time (e.g., near real-time). Near real-time can mean real-time less a time delay for processing (e.g., determining) and/or transmitting the relevant consumer product information to the relevant consumer. The particular time delay can vary depending on the type and/or amount of the consumer product information, the processing speed(s) of the processing module(s) of system 300, the transmission capability of the communication hardware (as introduced below), the transmission distance, etc. However, in many embodiments, the time delay can be less than approximately one, five, ten, or twenty minutes.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Specifically, system 300 comprises a central computer system 301. In many embodiments, central computer system 301 can be similar or identical to computer system 100 (FIG. 1). Accordingly, central computer system 301 can comprise one or more processing modules and one or more memory storage modules (e.g., one or more non-transitory memory storage modules). In these or other embodiments, the processing module(s) and/or the memory storage module(s) can be similar or identical to the processing module(s) and/or memory storage module(s) (e.g., non-transitory memory storage modules) described above with respect to computer system 100 (FIG. 1). In some embodiments, central computer system 301 can comprise a single computer or server, but in many embodiments, central computer system 301 comprises a cluster or collection of computers or servers and/or a cloud of computers or servers. Meanwhile, central computer system 301 can comprise one or more input devices (e.g., one or more keyboards, one or more keypads, one or more pointing devices such as a computer mouse or computer mice, one or more touchscreen displays, etc.), and/or can comprise one or more display devices (e.g., one or more monitors, one or more touchscreen displays, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the processing module(s) and/or the memory storage module(s) of central computer system 301 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of central computer system 301. In a similar manner, the processing module(s) and the memory storage module(s) can be local and/or remote to each other.

In many embodiments, central computer system 301 is configured to communicate with one or more consumer computer systems 302 (e.g., a consumer computer system 303) of one or more consumers. For example, the consumer(s) can interface (e.g., interact) with central computer system 301, and vice versa, via consumer computer system(s) 302 (e.g., consumer computer system 303). Accordingly, in many embodiments, central computer system 301 can refer to a back end of system 300 operated by an operator and/or administrator of system 300, and consumer computer system(s) 302 can refer to a front end of system 300 used by one or more users of system 300 (i.e., the consumer(s)). In these or other embodiments, the operator and/or administrator of system 300 can manage central computer system 301, the processing module(s) of computer system 301, and/or the memory storage module(s) of computer system 301 using the input device(s) and/or display device(s) of central computer system 301. In some embodiments, system 300 can comprise consumer computer system(s) 302 (e.g., consumer computer system 303).

Like central computer system 301, consumer computer system(s) 302 each can be similar or identical to computer system 100 (FIG. 1), and in many embodiments, each of consumer computer system(s) 302 can be similar or identical to each other. In many embodiments, consumer computer system(s) 302 can comprise one or more desktop computer devices, one or more wearable user computer devices, and/or one or more mobile devices, etc. At least part of central computer system 301 can be located remotely from consumer computer system(s) 302.

In some embodiments, a mobile device can refer to a portable electronic device (e.g., an electronic device easily conveyable by hand by a person of average size) with the capability to present audio and/or visual data (e.g., images, videos, music, etc.). For example, a mobile device can comprise at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can comprise a volume and/or weight sufficiently small as to permit the mobile device to be easily conveyable by hand. For examples, in some embodiments, a mobile device can occupy a volume of less than or equal to approximately 189 cubic centimeters, 244 cubic centimeters, 1790 cubic centimeters, 2434 cubic centimeters, 2876 cubic centimeters, 4056 cubic centimeters, and/or 5752 cubic centimeters. Further, in these embodiments, a mobile device can weigh less than or equal to 3.24 Newtons, 4.35 Newtons, 15.6 Newtons, 17.8 Newtons, 22.3 Newtons, 31.2 Newtons, and/or 44.5 Newtons.

Exemplary mobile devices can comprise, but are not limited to, one of the following: (i) an iPod®, iPhone®, iPod Touch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia®, Surface Pro™, or similar product by the Microsoft Corporation of Redmond, Wash., United States of America, and/or (iv) a Galaxy™, Galaxy Tab™, Note™, or similar product by the Samsung Group of Samsung Town, Seoul, South Korea. Further, in the same or different embodiments, a mobile device can comprise an electronic device configured to implement one or more of (i) the iOS™ operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by Google, Inc. of Mountain View, Calif., United States, (v) the Windows Mobile™, Windows Phone™, and Windows 10 (Mobile)™ operating systems by Microsoft Corporation of Redmond, Wash., United States of America, or (vi) the Symbian™ operating system by Nokia Corp. of Keilaniemi, Espoo, Finland.

In further embodiments, central computer system 301 can be configured to communicate with software (e.g., one or more web browsers, one or more mobile software applications, etc.) of the consumer computer system(s) 302 (e.g., consumer computer system 303). For example, the software can run on one or more processing modules and can be stored on one or more memory storage modules (e.g., one or more non-transitory memory storage modules) of the consumer computer system(s) 302 (e.g., consumer computer system 303). In these or other embodiments, the processing module(s) of the consumer computer system(s) 302 (e.g., consumer computer system 303) can be similar or identical to the processing module(s) described above with respect to computer system 100 (FIG. 1). Further, the memory storage module(s) (e.g., non-transitory memory storage modules) of the consumer computer system(s) 302 (e.g., consumer computer system 303) can be similar or identical to the memory storage module(s) (e.g., non-transitory memory storage module(s)) described above with respect to computer system 100 (FIG. 1). Exemplary web browsers can include (i) Firefox® by the Mozilla Organization of Mountain View, Calif., United States of America, (ii) Internet Explorer® by the Microsoft Corp. of Redmond, Wash., United States of America, (iii) Chrome™ by Google Inc. of Menlo Park, Calif., United States of America, (iv) Opera® by Opera Software of Oslo, Norway, and (v) Safari® by Apple Inc. of Cupertino, Calif., United States of America.

Meanwhile, in many embodiments, central computer system 301 also can be configured to communicate with one or more databases 312. The database can comprise a product database that contains information about products sold by a retailer. Database(s) 312 can be stored on one or more memory storage modules (e.g., non-transitory memory storage module(s)), which can be similar or identical to the one or more memory storage module(s) (e.g., non-transitory memory storage module(s)) described above with respect to computer system 100 (FIG. 1). Also, in some embodiments, for any particular database of database(s) 312, that particular database can be stored on a single memory storage module of the memory storage module(s) and/or the non-transitory memory storage module(s) storing database(s) 312 or it can be spread across multiple of the memory storage module(s) and/or non-transitory memory storage module(s) storing database(s) 312, depending on the size of the particular database and/or the storage capacity of the memory storage module(s) and/or non-transitory memory storage module(s).

In these or other embodiments, the memory storage module(s) of central computer system 300 can comprise some or all of the memory storage module(s) storing database(s) 312. In further embodiments, some of the memory storage module(s) storing database(s) 312 can be part of consumer computer systems 302 and/or one or more third-party computer systems (i.e., other than central computer system 301 and consumer computer systems 302), and in still further embodiments, all of the memory storage module(s) storing database(s) 312 can be part of consumer computer systems 302 and/or the third-party computer system(s). Like central computer system 301 and consumer computer system(s) 302, when applicable, each of the third-party computer system(s) can be similar or identical to computer system 100 (FIG. 1). Notably, the third-party computer systems are omitted from the drawings to better illustrate that database(s) 312 can be stored at memory storage module(s) of central computer system 301, consumer computer system(s) 302, and/or the third-party computer systems, depending on the manner in which system 300 is implemented.

Database(s) 312 each can comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between central computer system 301, consumer computer system(s) 302 (e.g., consumer computer system 303), and/or database(s) 312 can be implemented using any suitable manner of wired and/or wireless communication. Accordingly, system 300 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc. Exemplary LAN and/or WAN protocol(s) can comprise Data Over Cable Service Interface Specification (DOCSIS), Institute of Electrical and Electronic Engineers (IEEE) 802.3 (also known as Ethernet), IEEE 802.11 (also known as WiFi), etc. Exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, and the like. The specific communication software and/or hardware implemented can depend on the network topologies and/or protocols implemented, and vice versa. In many embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.)

For convenience, the functionality of system 300 is described herein as it relates particularly to consumer computer system 303 and a single consumer. But in many embodiments, the functionality of system 300 can be extended to each of consumer computer system(s) 302 and/or to multiple consumers. In these extended examples, in some embodiments, single consumers can interface (e.g., interact) with central computer system 301 with multiple consumer computer systems of consumer computer system(s) 302 (e.g., at different times). For example, a consumer could interface with central computer system 301 via a first consumer computer system (e.g., a desktop computer), such as, for example, when interfacing with central computer system 301 from home, and via a second consumer computer system (e.g., a mobile device), such as, for example, when interfacing with central computer system 301 away from home.

Managing inventory is an important aspect for a retailer. A retailer cannot sell an item unless the retailer has already purchased the item. A large department store often has many types of products that sell throughout a calendar year. This can include items such as groceries, health products, automotive products, and the like. Forecasting of these types of items might be considered easier because a retailer can always order more cereal for the next week if it runs out in one particular week.

Seasonal goods can be different. Certain types of items are sold only during a certain time of the year. Examples can include items specific to a holiday (e.g., Valentine's Day candy or Christmas trees), sporting goods, and “back-to-school” items. Other examples can include apparel. While some types of apparel are stocked throughout a calendar year (e.g., socks and shoes), other types of apparel are specific to a certain time of year. Examples can include coats, hats, gloves, and thicker clothing for winter, and swimwear and thinner clothing for the summer.

One potential issue that can occur with seasonal items in general and seasonal apparel in particular is that certain seasonal items might be available to a retailer only for a short period of time. For example, the manufacturer of winter clothing might manufacture the winter clothing only for a short period of time before transitioning to the manufacture of summer clothing. If a retailer sells out of a particular piece of winter clothing before the end of the winter selling season, the retailer might not be able to replenish its stock of that piece of winter clothing because the vendor of the winter clothing is no longer manufacturing the winter clothing. The result is lost sales. A particular retailer might have been able to sell 100 winter coats during the winter, but only sold 50 because it stocked only 50 coats. The next year, when orders are being placed, the orders may be made based on a forecast that was based on the sale of 50 coats. It is desirable to more accurately forecast the inventory to be ordered to avoid the problem of lost sales.

A stock keeping unit (SKU) is a distinct type of item for sale and all attributes (size, color, etc.) associated with the item that distinguishes it from other item. Typically, each SKU has a unique identifier associated with it. In other words, while a particular winter coat might be an item, there can be several different SKUs of the same winter coat. There can be a SKU for the red coat of size small, another SKU for the red coat of size medium, another SKU for the blue coat of size large, and so on.

When a retailer creates a demand forecast, the forecast can be for each individual SKU. In other words, the retailer can forecast how many red, size large coats they will sell, how many blue, size medium coats they will sell, and so on for each color and size permutation.

One problem with a demand forecast of a single SKU is that such a forecast is typically based on past sales. For the reasons discussed above, past sales might not be accurate because of incomplete data. For example, a particular piece of summer clothing might be on sale starting in January. However, because the retailer did not order enough of a particular SKU, the retailer might sell out of the SKU by the end of May, while other SKUs last through August. A demand forecast for that SKU based on the data for June and July might incorrectly neglect to take into consideration the fact that there are potential sales in June and July that might have been missed because the particular SKU sold out early.

With seasonal goods, inventory purchasing decisions can be important because of the short time frame where sales can occur and the rapid conversion of preseason to post-season pricing expectations of customers. To solve for this problem, a system and method has been developed that analyzes historical sales data, determines a time-varying price sensitivity throughout the season, imputes sales when the item went out of stock or was on steep discount, optimizes the price and sales across time, and forecasts year over year adjustments to determine an optimal inventory level for each SKU to support the season.

There are various goals to be solved. A retailer seeks to create as accurate a demand forecast as possible. This might involve imputing sales to a SKU from related SKUs or other items on a hierarchy of SKUs. After creating such a demand forecast, the demand forecast can be adjusted to take into account any pricing discounts, because sales of a product can be greatly influenced by pricing discounts. The adjusted demand forecast can then be used to order SKUs for the next shopping season involving the SKUs at issue. Each of these aspects will be discussed in more detail below.

In order to provide a more accurate forecast, the forecast might take into account a hierarchy of related SKUs. In other words, while the number of blue coats sold might be different from the number of red coats sold, the sales pattern (e.g., how many of each are sold each week) might be similar for both red coats and for blue coats and for each size. Such a technique can be called “information borrowing.”

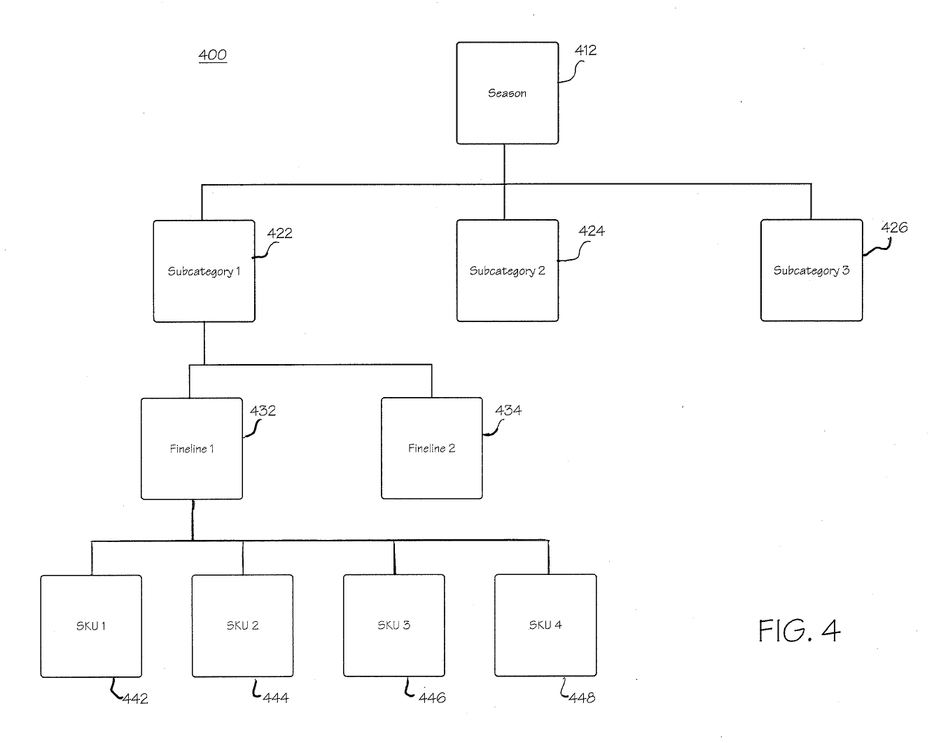

A hierarchy of goods can be used to allow “information borrowing” to occur at different levels of the hierarchy. FIG. 4 presents an illustration of an exemplary hierarchy. A hierarchy 400 for a season 412 is presented in FIG. 4. A season can indicate a shopping season as well as a calendar season. A calendar season can be spring, summer, autumn, and winter. A shopping season can include any period of time during which special sales can happen. Exemplary shopping seasons can include “back-to-school” and “Black Friday” as well as calendar seasons such as winter and summer. Under season 412, there can be multiple subcategories, such as subcategories 422, 424, and 426. While three subcategories are illustrated in FIG. 4, it should be understood that other numbers of subcategories can be used. Within each subcategory can be one or more finelines. A fineline is a group of related SKUs. In some embodiments, similarity can be based on characteristics of the items. In some embodiments, a fineline can be created using similarity of sales. Other characteristics can be used to create a fineline. A subcategory contains two or more related finelines. While only one level of subcategories is shown in FIG. 4, it should be understood that additional levels of subcategories can also be used.

FIG. 4 illustrates fineline 432 and fineline 434 under subcategory 422. While only one subcategory is shown as having finelines in FIG. 4, it should be understood that each subcategory can have one or more finelines. Under fineline 434 is another hierarchy. In FIG. 4, there are SKUs 442, 444, 446, and 448 under fineline 432. Again, while only one fineline is shown as having SKUs in FIG. 4, it should be understood that each fineline can have multiple SKUs under it.

Information borrowing can involve imputing the sales of similar SKUs into the forecast of another SKU. With reference to FIG. 4, similar SKUs can be SKUs of the same fineline, such as SKUs 442, 444, 446, and 448.

In a similar manner, information borrowing can be used between finelines belonging to the same category, such as finelines 432 and 434. Information borrowing can also be used between one or more subcategories, such as subcategories 422, 424, and 426.

Information borrowing involves using prior sales data for other SKUs in creating a demand forecast. A demand forecast can be created in one of a variety of different manners. In some embodiments, a demand forecast can be created using a multilevel mixed effect model. Various types of mixed effect models can be used. Some mixed effect models may use nested random effects. Imputation can then follow from a linear mixed effect based Best Linear Unbiased Predictor (BLUP). For any linear combination or rollup of items, the same linear combination of imputations is also a BLUP. A BLUP can be used for the estimation of random effects. The result is that entire sales curves can exist at the item level, instead of a few repeated measurements.

An exemplary multilevel mixed effects model that solves the above-described problems operates as described below.

For an item j within fineline i for a given end date, the log-sales can be written as follows:

yᵢⱼ(t)=+Xβ+uᵢ(t)+vᵢⱼ(t)+εᵢⱼ(t)

where Xβ comprises the fixed effects—X is the design matrix and β are the corresponding fixed effect coefficients. The random effects at the fineline level and at the item-within-fineline level are given by uᵢ(t) and vᵢⱼ(t) respectively. Assuming the log sales are observed for a total of t=1, . . . , T time points, these random effects can be assumed to be distributed as

$$( \begin{matrix}{u}_{i} ( T ) \\ ⋮ \\ {u}_{i} ( T )\end{matrix} ) ∼ N ( 0 , {σ}_{1}^{2} {R}_{1} ) , ( \begin{matrix}{v}_{ij} ( 1 ) \\ ⋮ \\ {v}_{ij} ( T )\end{matrix} ) ∼ N ( 0 , {σ}_{2}^{2} {R}_{2} )$$

Finally, we assume the errors to be i.i.d. normal εᵢⱼ(t)˜N(0,σ²).

If the covariance matrices R₁ and R₂ are given or pre-estimated, then the above mixed effect model can be rewritten into a more computationally tractable form as follows

yᵢⱼ(t)=Xβ+Σₖuᵢₖψₖ(t)+Σₗvᵢⱼₗφₗ(t)+εᵢⱼ(t),

where {ψₖ(t)} and {φₗ(t)}ₗ are eigen-functions for the covariance matrices R₁ and R₂; and {uᵢₖ}ₖ and {vᵢⱼₗ}ₗ are the corresponding random loadings or coefficients which can now be assumed to be independent.

Referring back to FIG. 4, demand forecasts for any SKU at the same level (such as SKUs 442, 444, 446, and 448) can be improved by imputing demand from other SKUs at the same level in an information borrowing scheme.

At the fineline level (such as fineline 432 or fineline 434), the demand forecast for each of the SKUs within the fineline can be aggregated with the demand for other finelines. The demand forecast for each SKU can be used as calculated or using an information borrowing scheme when determining the demand forecast of the fineline. Such a process can be called “rolling up.”

In a similar manner, the demand forecast for each fineline within a subcategory can be rolled up into a subcategory demand forecast. Again, the demand forecast being rolled up might be calculated using an information borrowing scheme such as described above.

The result of such an information borrowing step is that a more accurate demand forecast can be created for each SKU because “missing” information for a SKU is imputed from other SKUs (or missing information for a fineline is imputed from another fineline).

In some embodiments, after a demand estimation is made, a correction can be made to account for historical sales due to promotions (such as price reductions or other special offers). The correction for promotions can be made at any level of the hierarchy presented in FIG. 4. The reason for this correction is that the effect of price discounts on the demand of a SKU should be taken into account in order to create more accurate demand forecasts.

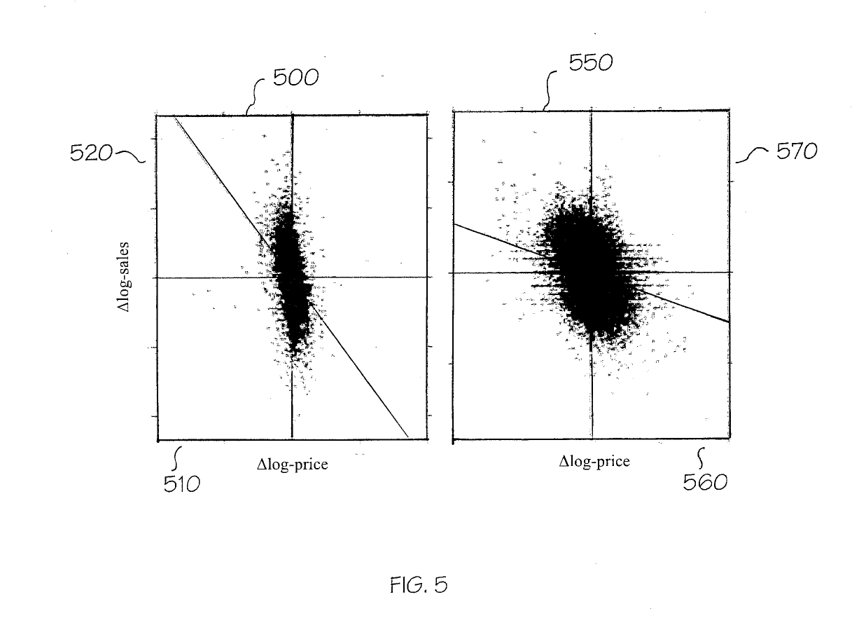

FIG. 5 illustrates a sales/price scatter plot for two exemplary finelines. Graph 500 depicts a sales/price scatter plot for a fineline related to televisions. X-axis 510 is the change in log of price. Y-axis 520 is the change in log of the sales. Graph 550 depicts a sales/price scatter plot for a fineline related to wireless accessories. X-axis 560 is the change in log of price. Y-axis 570 is the change in log of the sales. Each dot on the scatter plot represents the sales of an item given a relative change to the price of the item.

One can see that the shape of graph 500 is much different than the shape of graph 550. Graph 500 is steeper, and graph 550 is more of a circular distribution. What these shapes indicate is that the items being depicted in graph 500 are much more sensitive to price changes than the items depicted in graph 550. In graph 500, a small increase in the price (seen as moving right along X-axis 510) results in a sharp decrease in sales (seen as moving downward along Y-axis 520). In contrast, graph 550 has a more circular distribution, meaning that small increases/decreases in price do not greatly affect sales or demand.

Price elasticity (also known as price elasticity of demand) is a measure of the demand of how the demand of a good changes when price is changed. Some goods are more responsive to changes in price than others. For example, a low priced good might not see a large increase in sales when a 10% price discount is available, because the item is already inexpensive. However, more expensive items might see a large increase in sales when a 10% discount is applied.

Price elasticity is typically measured by dividing the change in demand by the change in price. Goods with a price elasticity of between −1 and 0 are deemed to have inelastic demand. At this level, there is less benefit to a retailer to offer a discount for a particular item. Goods with a price elasticity of less than −1 have elastic demand and there is a greater benefit to a retailer to offer a discount to these goods.

There also is a difference between a short-term elasticity (αₛᵣ) and a long-term elasticity (αₗᵣ). Short-term elasticity is the immediate effect of a price change. This effect however lessens over time for a variety of different reasons and the long-term elasticity measures the residual effect of the price changes on the demand in the long-run. For example, competing retailers may have matched the price change or customer expectations as to prices change over time (e.g., initially, a $500 item being sold for $450 may appear to be a great deal for customers. Over time, however, $450 becomes the expected price and the continued pricing of the item at $450 results in no more increased demand.)

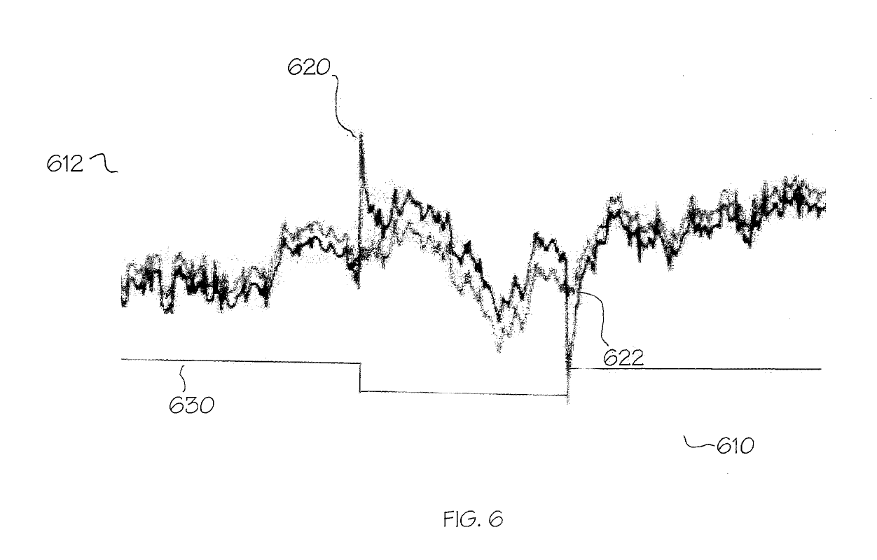

FIG. 6 illustrates a graph 600 of sales over time along with a price graph over the same time period. The x-axis 610 represents time, y-axis 612 represents sales, and y-axis 614 represents price. First sales data 620 represents the actual sales of an exemplary item over the given time period. Price data 630 represents the price of the exemplary item over the same time period. As can be seen, the price stays the same except for a certain time period in which the price is lowered. As can be seen in first sales data 620, the sales spike when the price is lowered. When the price is raised back to the previous price, there is a noticeable lowering of sales. The above-presented equation results in adjusted sales data 622, which adjusts the sales based on the price of the item.

Creating a demand forecast using first sales data 620 might result in an inaccuracies because additional sales due to a lowering of the price was not taken into account. Instead, adjusted sales data 622 is used to create the demand forecast, resulting in a more accurate order of goods for the next season.

An autoregressive distributed lag (ARDL) price-elasticity model has been developed that provides estimates for short-term well as the long-term effects of price changes on sales by category:

Δs_{i,t}=(μ+μᵢ)+(αₛᵣ+α_{sr,i})Δp_{i,t}+αₗᵣp_{i,t-1}−γs_{i,t-1}+e_{i,t},

μᵢ˜N(0,σ₁²), αᵢ˜N(0,σ₂²),

e_{i,t}˜N(0,σ²),

where Δs is log of the sales, i represents each item, t represents a time period for which the formula is applicable (typically a week in some embodiments), αₛᵣ is the overall short-term price elasticity for an entire category, α_{sr,i} is the short-term price elasticity for a particular item, αₗᵣ is the long-term price elasticity, γ is the decay (a measure of how quickly an item moves from short-term behavior to long-term behavior), p_{i,t} is the price for a current time period and p_{i,t-1} is the price for a previous time period, μ is the overall mean across all items, and μᵢ is the mean for a specific item.

Such a formula can also be used to plan pricing in the future. In other words, instead of removing price effects to find a true demand, a price decrease at the end of the season (e.g., an end-of-summer clearance sale) can be planned for when ordering items for the season. In such a manner, a retailer can plan for an end-of-season promotion instead of merely using such a promotion to clear out inventory, thus resulting in more revenue for the retailer. Performing such a calculation would involve using a price-elasticity model (such as the ARDL model described above) to calculate demand for sales promotions of different levels, and at different time periods. One would then determine which discount or sales promotion results in the highest sales. For certain products, an “end-of-season” clearance promotion might result in the highest sales. For other products, a promotion targeted at a certain holiday (e.g., Memorial Day or July 4^{th} for summer goods, Christmas for winter goods), might be more productive. The length of the promotion can also be determined. As described above, a promotion loses effectiveness after a certain period of time and it would be desirable to determine the optimum length of time for a promotion.

Estimates of total demand can be created for any combination of fineline, size, and color. The estimates allows better inventory ordering for future seasons. Price elasticity estimates can also allow the steering of item discounts in a desired direction.

FIG. 7 shows a flowchart illustrating the operation of a method 700 of optimizing inventory purchasing of seasonal goods. Method 700 is merely exemplary and is not limited to the embodiments presented herein. Method 700 can be employed in many different embodiments or examples not specifically depicted or described herein. In some embodiments, the procedures, the processes and/or the activities of method 700 can be performed in the order presented. In other embodiments, the procedures, the processes, and/or the activities of method 700 can be performed in any other suitable order. In still other embodiments, one or more of the procedures, the processes, and/or the activities of method 700 can be combined or skipped. In some embodiments, method 700 can be implemented by computer system 100 (FIG. 1). In some embodiments, method 700 can be implemented by central computer system 301 (FIG. 3).

When it is desired to optimize the inventory purchasing, historical sales data is accessed (block 702). Historical price data can also be accessed at this time. With the advent of computerized inventory tracking, it has become easier for a retailer to track historical sales of every SKU sold by a company. This is typically accomplished by storing historical sales data and historical price data in a database. For most goods, it is typical to retrieve historical sales data for a similar time period. For seasonal goods, this typically means sales data from one year previous. Thus, if start date for selling seasonal goods is May 1, 2016, sales data starting from approximately May 1, 2015 is used. It should be understood that the date might not be exactly one year previous. For example, a retailer may use a weekly schedule and thus retrieve data from 52 weeks previous. Other types of seasonal goods might have quarter-long seasons, thus historical data from the previous quarter can be retrieved.

Each SKU is associated with a fineline (block 704). It should be understood that the fineline may have been created in the past or it can be created when the demand forecast is performed. As described above, a fineline can include multiple SKUs with similar sales patterns or other characteristics. In the example of apparel, a fineline can include SKUs of a similar style that are in a different color or a different size. The retrieving of historical sales data at block 702 can include retrieving sales data for each SKU in the fineline.

Historical sales data for other SKUs in the fineline are imputed to each SKU in the fineline (block 706). The process by which imputation occurs and the reason for the imputation is described in more detail above. In brief, imputation of sales data from other SKUs can correct for sales that are missing because of lack of stock.

Demand data is calculated for each SKU (block 708). Thereafter, the retailer can order goods based on the demand data (block 710). The result is more accurate inventory purchasing. For seasonal goods in particular, accurate inventory purchasing can be important because of the possibility that further goods might not be available to the retailer after a selling season begins.

Turning ahead in the figures, FIG. 8 illustrates a block diagram of a system 800 that is capable of performing disclosed embodiments. System 800 is merely exemplary and is not limited to the embodiments presented herein. System 800 can be employed in many different embodiments or examples not specifically depicted or described herein. In some embodiments, certain elements or modules of system 800 can perform various procedures, processes, and/or acts. In other embodiments, the procedures, processes, and/or acts can be performed by other suitable elements or modules.

In a number of embodiments, system 800 can include historical sales data retrieval module 802. In certain embodiments, historical sales data retrieval module 802 can perform block 702 (FIG. 7) of retrieving historical sales data.

In a number of embodiments, system 800 can include fineline association module 804. In certain embodiments, fineline association module 804 can perform block 704 (FIG. 7) of associating a SKU with a fineline.

In a number of embodiments, system 800 can include data imputation module 806. In certain embodiments, data imputation module 806 can perform block 706 (FIG. 7) of imputing data from other SKUs in the fineline.

In a number of embodiments, system 800 can include demand calculation module 808. In certain embodiments, demand calculation module 808 can perform block 708 (FIG. 7) of calculating demand.

In a number of embodiments, system 810 can include ordering module 810. In certain embodiments, ordering module 810 can perform block 710 (FIG. 7) of ordering goods based on the calculated demand.

Embodiments can also be used to account for cannibalization effects. There are several different types of cannibalization that can be possible. One example is a reduction in sales, revenue, or market share as a result of the introduction of a new product. For example, a new smartphone by Samsung or Apple can result in a reduction of sales for existing smartphones by Samsung or Apple. While this type of cannibalization can be most noticeable for high-profile products such as smartphones, cannibalization can occur with many types of products. For example, the introduction of a new shirt color can have cannibalization effects on other shirt colors.

There are different factors to be accounted for in dealing with cannibalization effects. For example, there can be a spike in sales when a new product is introduced or if a related product sells out. If a particular shirt was available only in blue and in red in one period, then is made available in black in a second period, the sales of black shirts can be larger than would be predicted with just the sales of the blue shirts and red shirts. (Cannibalization is typically more common among colors, but not among sizes.) A mixed-effect model typically has to take into consideration whether the correlation between two SKUs or two finelines is positive correlation or negative correlation. While in general, there is a positive correlation between SKUs or finelines, there can also be a negative correlation in certain situations (for example, the spike situation discussed above).

In general, correlation is determined between two SKUs or between two finelines. In some embodiments, it might not be possible to find correlation between every pair of SKUs or pair of finelines. In some embodiments, correlation between certain pairs of items can be imputed by the correlation between other pairs of items. For example, if the correlation between item A and item B can be determined and the correlation between item A and item C can be determined, the correlation between item B and item C can be imputed from the other two correlations.

It should also be understood that cannibalization is not limited to situations where new SKUs are introduced. Cannibalization effects can occur when one SKU of a fineline sells out, for example. Cannibalization effects can also occur between finelines.

Although the above embodiments have been described with reference to specific embodiments, it will be understood by those skilled in the art that various changes can be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-8 can be modified, and that the foregoing discussion of certain of these embodiments does not necessarily represent a complete description of all possible embodiments. For example, one or more of the procedures, processes, or activities of FIGS. 1-8 can include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that can cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processing modules; and
one or more non-transitory storage modules storing computing instructions configured to run on the one or more processing modules and perform the acts of:
accessing historical sales data related to a set of stock keeping units (SKUs) from a database;
associating, for each SKU in the set of SKUs, the SKU with a fineline comprising one or more SKUs with similar characteristics;
imputing historical sales data for each SKU in the set of SKUs in the fineline to each SKU in the fineline;
calculating demand data for each SKU in the set of SKUs based on the imputed historical sales data; and
ordering goods based on the demand data.

2. The system of claim 1 wherein the computing instructions are further configured to perform the acts of:
determining, for each fineline in a set of finelines, a subcategory comprising one or more finelines with similar characteristics to the fineline, wherein the set of finelines comprises the fineline; and
imputing historical sales data for each fineline in the set of finelines in the subcategory to each fineline in the set of finelines in the subcategory; wherein:
calculating the demand data further comprises calculating the demand data for each SKU based on the imputed historical sales data for the fineline.

3. The system of claim 1 wherein the computing instructions are further configured to perform the acts of:
correlating the historical price data with the historical sales data to calculate a corrected demand data for the SKU; wherein
ordering the goods further comprises ordering the goods based on the corrected demand data.

4. The system of claim 3 wherein:
receiving the historical price data comprises receiving the historical price data for each SKU in the fineline; and
calculating the demand data comprises calculating the corrected demand data for each SKU in the set of SKUs based on the imputed historical sales data and the imputed historical price data.

5. The system of claim 3 wherein the computing instructions are further configured to perform the acts of:
determining, for each SKU in the set of SKUs, a time period and discount amount for a sales promotion that maximizes demand for the SKU.

6. The system of claim 5 wherein:
determining the time period and discount amount for the sales promotion comprises using an autoregressive distributed lag (ARDL) price-elasticity model to calculate demand for multiple time periods and discount amounts to determine the time period and discount amount for the maximum demand.

7. The system of claim 1 wherein:
calculating the demand data comprises using a mixed-effect model with nested random effects.

8. The system of claim 7 wherein:
the mixed-effect model comprises the following equation for calculating demand:
yᵢⱼ(t)=Xβ+Σₖuᵢₖψₖ(t)+Σₗv_{ijlφl}(t)+εᵢⱼ(t),
where:
$$( \begin{matrix}{u}_{i 1} \\ ⋮ \\ {u}_{iK}\end{matrix} ) ∼ N ( 0 , {σ}_{1}^{2} {R}_{1} ) , ( \begin{matrix}{v}_{ij 1} \\ ⋮ \\ {v}_{ij L}\end{matrix} ) ∼ N ( 0 , {σ}_{2}^{2} {R}_{2} ) and {∈}_{ij} ( t ) ∼ N ( 0 , {σ}^{2} )$$

9. The system of claim 1 wherein:
imputing the historical sales data for each SKU in the fineline to each SKU in the fineline comprises using linear mixed effect based best linear unbiased predictors (BLUPs).

10. The system of claim 1 wherein the computing instructions are further configured to perform the acts of:
determining, for each fineline in a set of finelines, a subcategory comprising one or more finelines with similar characteristics to the fineline;
imputing historical sales data for each fineline in the set of finelines in the subcategory to each fineline in the set of finelines in the subcategory, wherein calculating the demand data comprises calculating the demand data for each SKU based on the imputed historical sales data for the fineline;
receiving historical price data for the SKU;
correlating the historical price data with the historical sales data to calculate a corrected demand data for the SKU, wherein
ordering the goods comprises ordering the goods based on the corrected demand data;
receiving the historical price data comprises receiving the historical price data for each SKU in the fineline;
calculating the demand data comprises calculating the corrected demand data for each SKU in the set of SKUs based on the imputed historical sales data and the imputed historical price data; and
determining, for each SKU in the set of SKUs, a time period and discount amount for a sales promotion that maximizes demand for the SKU, wherein:
determining the time period and discount amount for the sales promotion comprises using an autoregressive distributed lag (ARDL) price-elasticity model to calculate demand for multiple time periods and discount amounts to determine the time period and discount amount for the maximum demand.
calculating the demand data comprises using a mixed-effect model with nested random effects; and
the mixed-effect model comprises the following equation for calculating demand:
yᵢⱼ(t)=Xβ+Σₖuᵢₖψₖ(t)+Σₗv_{ijlφl}(t)+εᵢⱼ(t),
where:
$$( \begin{matrix}{u}_{i 1} \\ ⋮ \\ {u}_{iK}\end{matrix} ) ∼ N ( 0 , {σ}_{1}^{2} {R}_{1} ) , ( \begin{matrix}{v}_{ij 1} \\ ⋮ \\ {v}_{ij L}\end{matrix} ) ∼ N ( 0 , {σ}_{2}^{2} {R}_{2} ) and {∈}_{ij} ( t ) ∼ N ( 0 , {σ}^{2} ) .$$

11. A method comprising:
accessing historical sales data related to a set of stock keeping units (SKUs) from a database;
associating, for each SKU in the set of SKUs, the SKU with a fineline comprising one or more SKUs with similar characteristics;
imputing historical sales data for each SKU in the set of SKUs in the fineline to each SKU in the fineline;
calculating demand data for each SKU in the set of SKUs based on the imputed historical sales data; and
ordering goods based on the demand data.

12. The method of claim 11 further comprising:
determining, for each fineline in a set of finelines, a subcategory comprising one or more finelines with similar characteristics to the fineline, wherein the set of finelines comprises the fineline; and
imputing historical sales data for each fineline in the set of finelines in the subcategory to each fineline in the set of finelines in the subcategory; wherein:
calculating the demand data further comprises calculating the demand data for each SKU based on the imputed historical sales data for the fineline.

13. The method of claim 11 further comprising:
receiving historical price data for the SKU; and
correlating the historical price data with the historical sales data to calculate a corrected demand data for the SKU; wherein
ordering the goods further comprises ordering the goods based on the corrected demand data.

14. The method of claim 13 wherein:
receiving the historical price data comprises receiving the historical price data for each SKU in the fineline; and
calculating the demand data comprises calculating the corrected demand data for each SKU in the set of SKUs based on the imputed historical sales data and the imputed historical price data.

15. The method of claim 13 further comprising:
determining, for each SKU in the set of SKUs, a time period and discount amount for a sales promotion that maximizes demand for the SKU.

16. The method of claim 15 wherein:
determining the time period and discount amount for the sales promotion comprises using an autoregressive distributed lag (ARDL) price-elasticity model to calculate demand for multiple time periods and discount amounts to determine the time period and discount amount for the maximum demand.

17. The method of claim 11 wherein:
calculating the demand data comprises using a mixed-effect model with nested random effects.

18. The method of claim 17 wherein:
the mixed-effect model comprises the following equation for calculating demand:
yᵢⱼ(t)=Xβ+Σₖuᵢₖψₖ(t)+Σₗv_{ijlφl}(t)+εᵢⱼ(t),
where:
$$( \begin{matrix}{u}_{i 1} \\ ⋮ \\ {u}_{iK}\end{matrix} ) ∼ N ( 0 , {σ}_{1}^{2} {R}_{1} ) , ( \begin{matrix}{v}_{ij 1} \\ ⋮ \\ {v}_{ij L}\end{matrix} ) ∼ N ( 0 , {σ}_{2}^{2} {R}_{2} ) and {∈}_{ij} ( t ) ∼ N ( 0 , {σ}^{2} )$$

19. The method of claim 11 wherein:
imputing the historical sales data for each SKU in the fineline to each SKU in the fineline comprises using linear mixed effect based best linear unbiased predictors (BLUPs).

20. The method of claim 11 further comprising:
determining, for each fineline in a set of finelines, a subcategory comprising one or more finelines with similar characteristics to the fineline;
imputing historical sales data for each fineline in the set of finelines in the subcategory to each fineline in the set of finelines in the subcategory, wherein calculating the demand data comprises calculating the demand data for each SKU based on the imputed historical sales data for the fineline;
receiving historical price data for the SKU;
correlating the historical price data with the historical sales data to calculate a corrected demand data for the SKU, wherein
ordering the goods comprises ordering the goods based on the corrected demand data;
receiving the historical price data comprises receiving the historical price data for each SKU in the fineline;
calculating the demand data comprises calculating the corrected demand data for each SKU in the set of SKUs based on the imputed historical sales data and the imputed historical price data; and
determining, for each SKU in the set of SKUs, a time period and discount amount for a sales promotion that maximizes demand for the SKU, wherein:
determining the time period and discount amount for the sales promotion comprises using an autoregressive distributed lag (ARDL) price-elasticity model to calculate demand for multiple time periods and discount amounts to determine the time period and discount amount for the maximum demand.
calculating the demand data comprises using a mixed-effect model with nested random effects; and
the mixed-effect model comprises the following equation for calculating demand:
yᵢⱼ(t)=Xβ+Σₖuᵢₖψₖ(t)+Σₗv_{ijlφl}(t)+εᵢⱼ(t),
where:
$$( \begin{matrix}{u}_{i 1} \\ ⋮ \\ {u}_{iK}\end{matrix} ) ∼ N ( 0 , {σ}_{1}^{2} {R}_{1} ) , ( \begin{matrix}{v}_{ij 1} \\ ⋮ \\ {v}_{ij L}\end{matrix} ) ∼ N ( 0 , {σ}_{2}^{2} {R}_{2} ) and {∈}_{ij} ( t ) ∼ N ( 0 , {σ}^{2} ) .$$
